(19) United States
(12) Patent Application Publication
(10) Pub. No.: US 2014/0258231 A1
(43) Pub. Date: Sep. 11, 2014

(54) DEVICE SYNCHRONIZATION POLICY MANAGEMENT

(71) Applicants: Eran Birk, Haifa (IL); Tarun Viswanathan, Folsom, CA (US); Oded Bar El, Zichron yaacov (IL)

(72) Inventors: Eran Birk, Haifa (IL); Tarun Viswanathan, Folsom, CA (US); Oded Bar El, Zichron yaacov (IL)

(21) Appl. No.: 13/976,112

(22) PCT Filed: Mar. 11, 2013
(86) PCT No.: PCT/US2013/030108

§ 371 Date: Jun. 26, 2013

(51) Int. Cl. G06F 17/30

(52) U.S. Cl. CPC G06F 17/30581
USPC 707/634

(57) ABSTRACT

Generally, this disclosure provides devices, methods and computer readable media for device synchronization policy management. The device may include a context determination module configured to determine a usage context associated with the device; a content determination module configured to determine a data content classification associated with data to be synchronized between the device and a cloud; a synchronization policy database configured to store synchronization policies, the policies based on the device usage context, the data content classification and a classification of the cloud type; and a synchronization policy management module configured to select a synchronization policy from the synchronization policy database and further configured to synchronize the data with the cloud based on the selected synchronization policy.

### FIELD

The present disclosure relates to device synchronization policy management, and more particularly, to device synchronization policy management based on content and context.

### BACKGROUND

Electronic devices and platforms, such as, for example, smartphones, laptops, tablets, computing device, and smart TVs are often capable of providing data content to the user of the device at any location and at any time. The data may be synchronized with one or more clouds or other types of servers and may be downloaded or uploaded over a wired or wireless communication network. The data may often be shared between multiple devices and through multiple clouds.

Security of the data content, however, is of increasing concern to users and enterprises. Existing synchronization techniques may apply broad security policies with rules based on generalizations or other broad assumptions. Existing synchronization techniques and policies also generally fail to account for the differing security characteristics that may be associated with the various types of clouds or the context associated with the usage of the device during synchronization.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates a top level system diagram of one exemplary embodiment consistent with the present disclosure;

FIG. 2 illustrates a block diagram of one exemplary embodiment consistent with the present disclosure;

FIG. 3 illustrates exemplary classifications and policies consistent with an embodiment of the present disclosure;

FIG. 4 illustrates a block diagram of another exemplary embodiment consistent with the present disclosure;

FIG. 5 illustrates a system diagram showing platforms consistent with an exemplary embodiment of the present disclosure;

FIG. 6 illustrates a flowchart of operations of another exemplary embodiment consistent with the present disclosure; and

FIG. 7 illustrates exemplary applications of synchronization policy consistent with an embodiment of the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure provides devices, methods and computer readable media for device synchronization policy management. Synchronization between a device and a cloud may be controlled by a synchronization policy that is based on multiple attributes or factors. These attributes may include the usage context of the device, the type of device, the type of cloud and a classification of the data to be synchronized. The usage context may include location, date and time. The data type may be classified down to a more detailed level of granularity, such as, for example, “personal” classification down to “family” classification and further down to “family pictures” classification. Cloud types may include, for example, enterprise clouds of varying levels of security, home clouds and public clouds. A synchronization policy management module may be configured to maintain a policy database and select and apply a policy from that database in response to determining one or more of the attributes listed above.

The device may be any type of wired or wireless device or platform including, for example, a smartphone, laptop, tablet, computer, or smart TV capable of transmitting or receiving data content over a network.

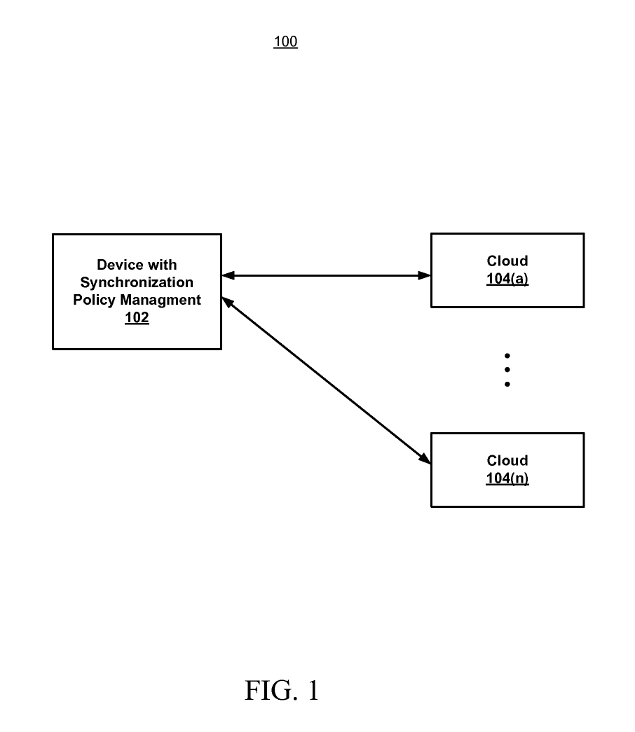

FIG. 1 illustrates a top level system diagram 100 of one exemplary embodiment consistent with the present disclosure. A device with synchronization policy management 102 is shown to be communicatively coupled to one or more clouds 104(a) through 104(n). Synchronization may include the transfer of data (e.g., downloading or uploading) between the device 102 and the clouds 104 in a manner consistent with a selected policy. Synchronization may also include the erasure or removal of data from the device or one or more of the clouds 104(a) through 104(n), also in accordance with the selected policy.

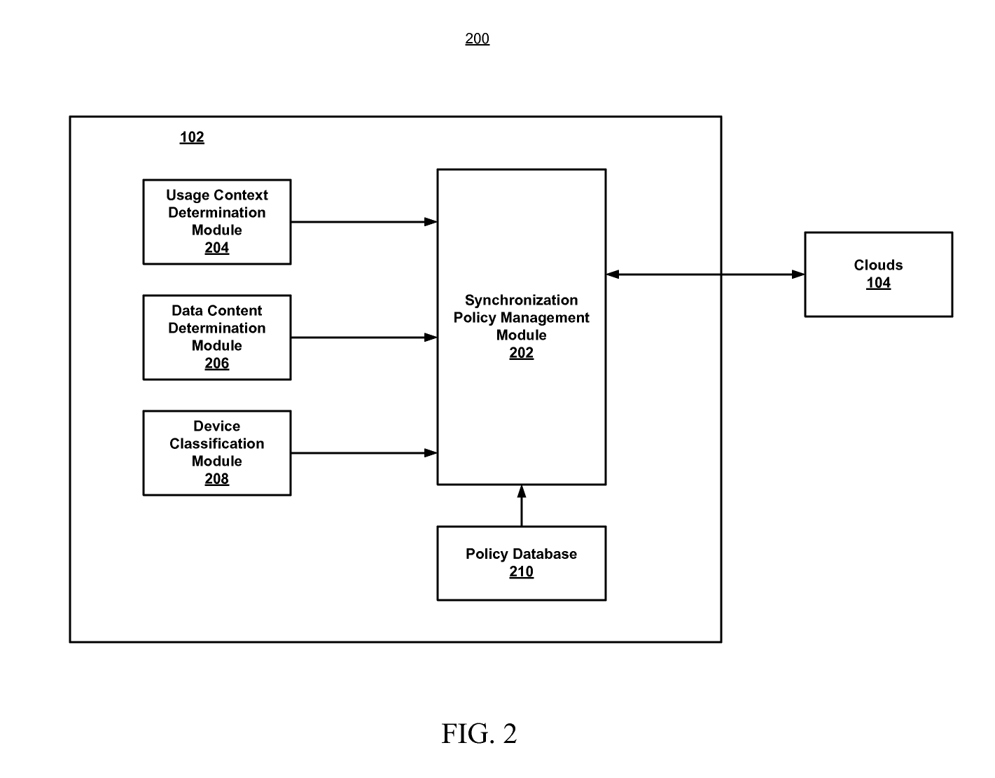

FIG. 2 illustrates a block diagram 200 of one exemplary embodiment consistent with the present disclosure. Device 102 is shown to include a synchronization policy management module 202, usage context determination module 204, data content determination module 206, device classification module 208 and policy database 210. The usage context determination module 204 may be configured to provide a context within which the device is being used. The context may include a location, date and time, or any other usage information that may be relevant to the synchronization of the device. For example, the user may decide that certain types of sensitive or private information should not be retained on his smartphone when leaving home. A policy may therefore exist to store this type of information on the user's home cloud but to erase it from the smartphone upon leaving home. As a further example, a policy may specify that the user's stock portfolio information is to be made available only during trading hours.

Data content determination module 206 may be configured to classify the data content to be synchronized. The data may be classified or categorized down to a desired level of detail or granularity as required by the user. For example data may be classified as “business-financial-sales-figures” as opposed to just “business,” or “personal-family-vacation-photos” as opposed to just “personal.” Synchronization policies may therefore be devised that are more closely targeted to a given scenario (e.g., combination of usage context and data content). These synchronization policies may be stored in a policy data database 210 for use by synchronization policy management module 202. In some embodiments, synchronization policy management module 202 may be a software agent installed on the device. The data content determination module 206 may classify the data based on user provided input or specifications associated with the data at or near the time of creation of the data. In some embodiments, the data content determination module 206 may classify the data based on information provided from the enterprise or other sources. The data content determination module 206 may also classify the data autonomously, based on history and tracking of similar, previously processed data or through the application of data classification rules.

Device classification module 208 may be configured to classify the device into one or more categories such as, for example, an enterprise provided phone versus a personal phone or a private device versus a shared device. A business phone may, for example, implement more security features than a personal phone but it may also handle more sensitive or private information. Either or both of these considerations may impact the security requirements for the device. The synchronization policies 210 and policy management module 202 may therefore be devised to further incorporate this additional device classification information into policy creation and execution.

Synchronization may be performed bi-directionally between the device and the cloud (e.g., from the device to the cloud and/or from the cloud to the device) and data content may be erased from either the device or the cloud based on the application of a policy to a context.

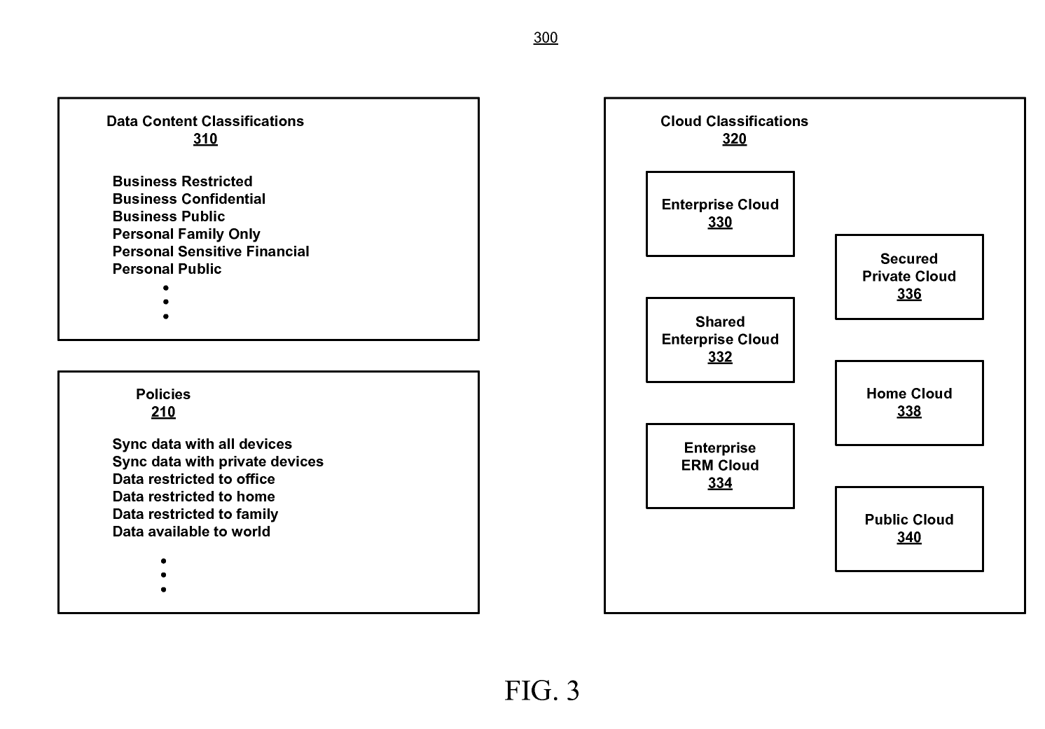

FIG. 3 illustrates exemplary classifications, policies and cloud types 300 consistent with an embodiment of the present disclosure. Shown are some exemplary data content classifications 310 which may, in some embodiments, include the categories of business restricted, business confidential, business public, personal family only, personal sensitive financial, and personal public. Also shown are some exemplary policies 210 which may, in some embodiments, include synchronize data with all devices, synchronize data with private devices, data is restricted to office, data is restricted to home, data is restricted to family, data is available to world. Also shown are some exemplary cloud types with which synchronization may occur. Cloud types may include enterprise clouds 330, shared enterprise clouds 332, enterprise rights management (ERM) clouds 334 (e.g, clouds offering encryption), secured private clouds 336, home clouds 338 and public clouds 340 (e.g., social networking clouds). These examples are provided for illustrative purposes to indicate that a broad range of possibilities are available and are not intended to limit the scope in any way.

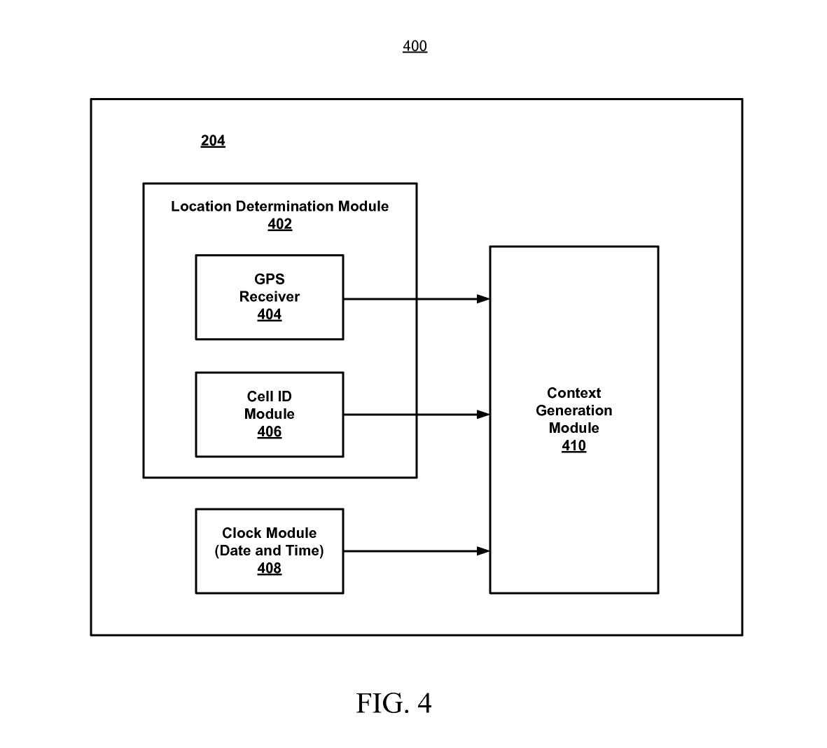

FIG. 4 illustrates a block diagram 400 of another exemplary embodiment consistent with the present disclosure. The usage context determination module 204 is shown to further include a location determination module 402, a clock module 408 and a context generation module 410. In some embodiments, the location determination module 402 may further include a Global Positioning System (GPS) receiver 404 and/or a cell identification module 406. The GPS receiver 404 may be employed to provide a current or recent location of the device. Motion tracking of the device, including velocity may also be provided by the GPS 404. Cell identification module 406 may be employed as an alternative or additional source of information to assist in the determination of the device location. For example, if the device is a smartphone or other mobile communication device, the identification of the serving cell base station (having a known location and service area) may provide an estimate of a geographic region within which the device is operating. Alternatively, the serving cell base station may provide the device with location information in the form of a transmitted message to the device. This may be particularly useful when GPS data is not available. Any other suitable means of location determination or estimation may also be employed.

Clock module 408 may be configured to provide a date and time associated with the usage of the device. The date and time, along with the location estimation described above, may be provided to the context generation module 410 to generate a current usage context for the device. A usage context may, for example, indicate that the device is being used within the home during the evening or that the device is being used in the office during business hours.

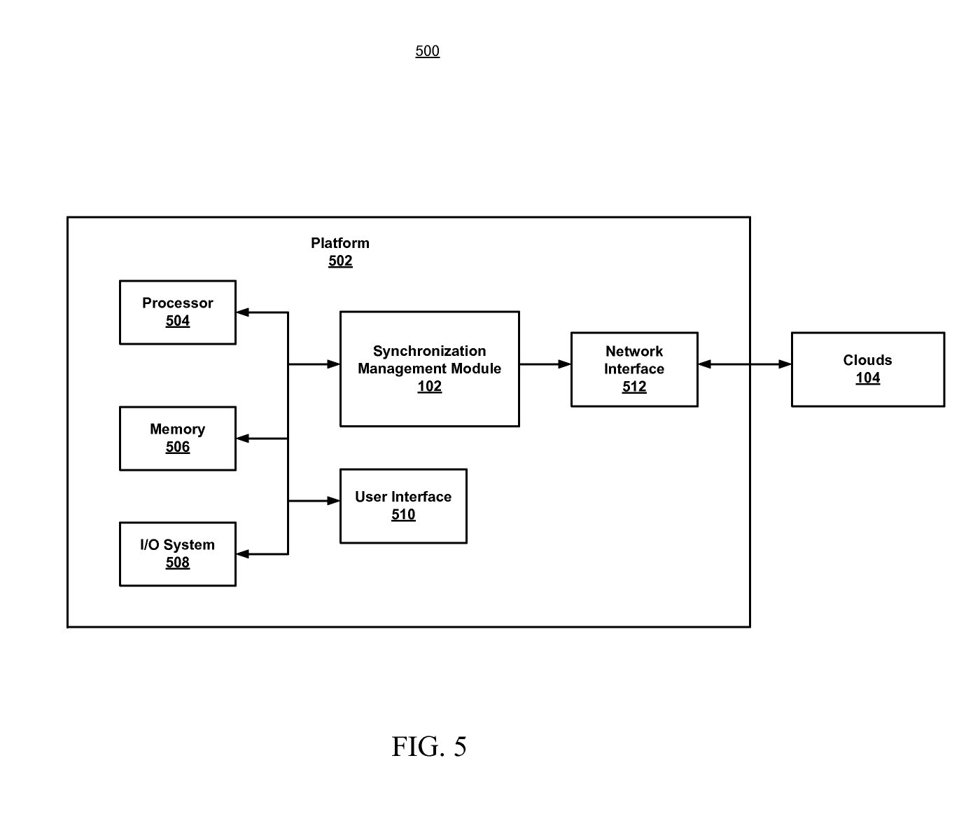

FIG. 5 illustrates a system diagram 500 showing platforms consistent with an exemplary embodiment of the present disclosure. A platform 102 may be a mobile communication device, such as, for example, a smartphone, a tablet or a laptop computing device configured to transmit or receive signals over a wireless or wired network. The platform may also be a smart TV or any other device configured to communicate over a network. In some embodiments, platform 102 may include a processor 504, memory 506, an input/output (I/O) system 508, a display/keyboard or other type of user interface (UI) 510 such as, for example, a touchscreen. The platform may also include a synchronization management module 102 as described previously. Any number of platforms 102 may transmit or receive signals through network interface 512 to one or more clouds 104.

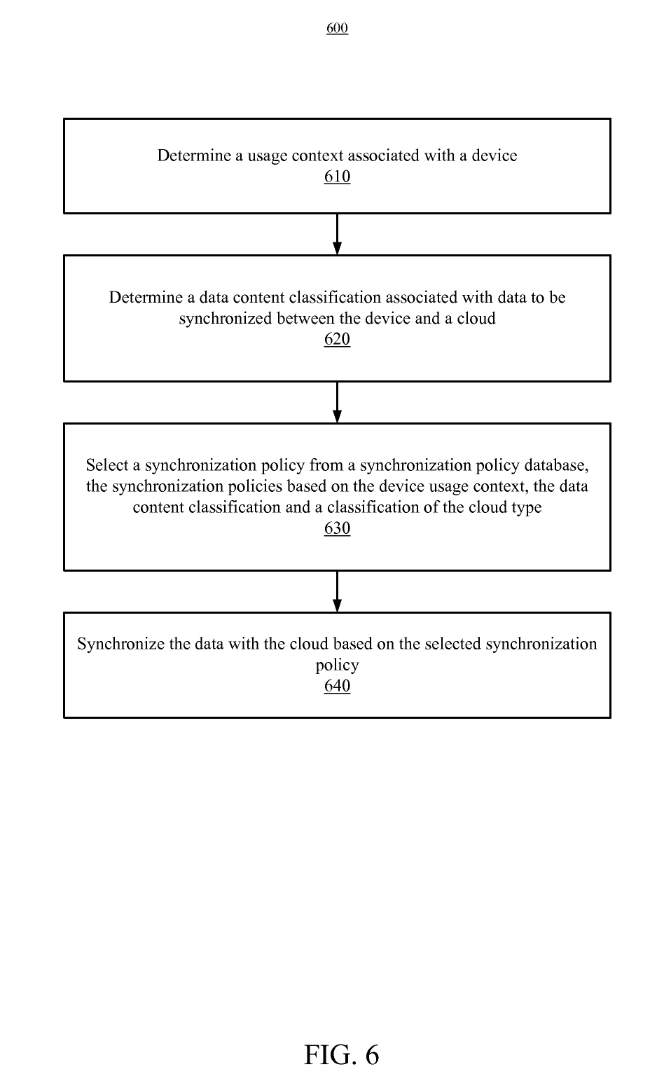

FIG. 6 illustrates a flowchart of operations 600 of another exemplary embodiment consistent with the present disclosure. The operations provide a method for device synchronization policy management. At operation 610, a usage context associated with the device is determined. At operation 620, a data content classification is determined. The classification is associated with data to be synchronized between the device and a cloud. At operation 630, a synchronization policy is selected from a synchronization policy database, the synchronization policies are based on the device usage context, the data content classification and a classification of the cloud type. At operation 640, the data is synchronized with the cloud based on the selected synchronization policy.

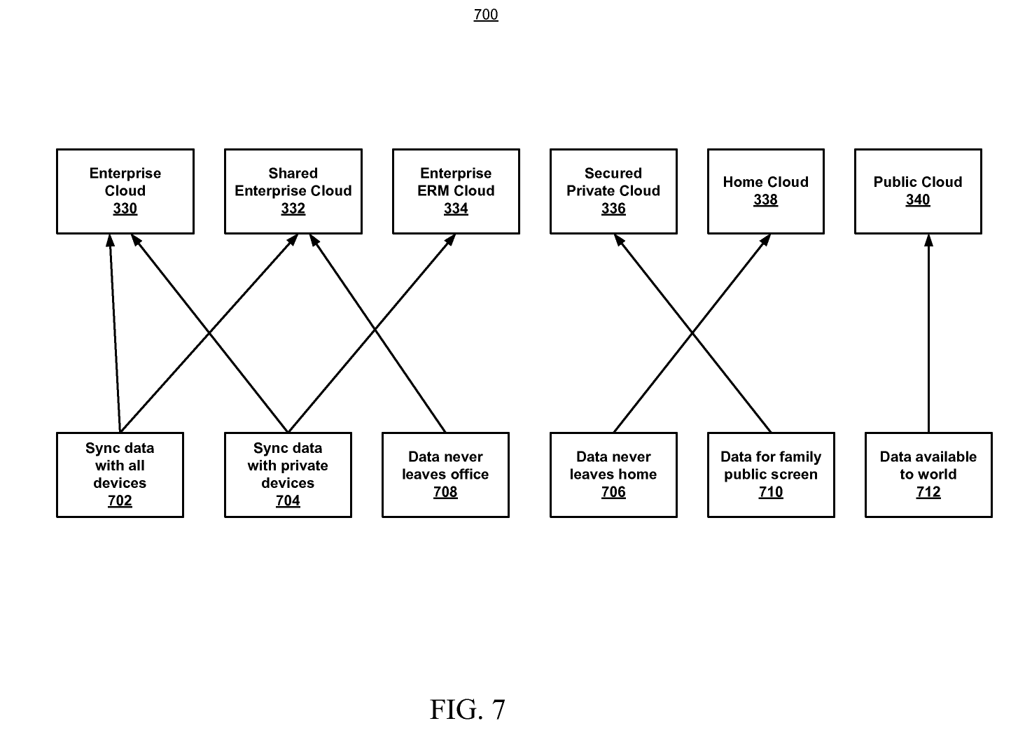

FIG. 7 illustrates exemplary applications of synchronization policy 700 consistent with an embodiment of the present disclosure. For example, data tagged as “sync data with all devices” 702 may be synchronized with an enterprise cloud 330 or a shared enterprise cloud 332. Continuing with this example, data tagged as “sync data with private devices” 704 may be synchronized with the enterprise cloud 330 or a shared enterprise ERM cloud 334, while data tagged as “data never leaves office” 708 may be synchronized with only the shared enterprise cloud 332. Similarly, data tagged as “data never leaves home” 706 may be synchronized with a home cloud 338, while data tagged as “data for family public screen” 710 may be synchronized with a secured private cloud 336 and data tagged as “data available to the world” 712 may be synchronized with a public cloud 340. It should be noted again that these examples are provided for illustrative purposes to indicate that a broad range of policies are possible and should not be construed to limit the scope in any way.

Embodiments of the methods described herein may be implemented in a system that includes one or more storage mediums having stored thereon, individually or in combination, instructions that when executed by one or more processors perform the methods. Here, the processor may include, for example, a system CPU (e.g., core processor) and/or programmable circuitry. Thus, it is intended that operations according to the methods described herein may be distributed across a plurality of physical devices, such as processing structures at several different physical locations. Also, it is intended that the method operations may be performed individually or in a subcombination, as would be understood by one skilled in the art. Thus, not all of the operations of each of the flow charts need to be performed, and the present disclosure expressly intends that all subcombinations of such operations are enabled as would be understood by one of ordinary skill in the art.

The storage medium may include any type of tangible medium, for example, any type of disk including floppy disks, optical disks, compact disk read-only memories (CD-ROMs), compact disk rewritables (CD-RWs), digital versatile disks (DVDs) and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

“Circuitry”, as used in any embodiment herein, may include, for example, singly or in any combination, hardwired circuitry, programmable circuitry, state machine circuitry, and/or firmware that stores instructions executed by programmable circuitry. An app may be embodied as code or instructions which may be executed on programmable circuitry such as a host processor or other programmable circuitry. A module, as used in any embodiment herein, may be embodied as circuitry. The circuitry may be embodied as an integrated circuit, such as an integrated circuit chip.

Thus, the present disclosure provides devices, systems, platforms, methods and computer readable media for device synchronization policy management. The following examples pertain to further embodiments.

The device may include a context determination module configured to determine a usage context associated with the device. The device of this example may also include a content determination module configured to determine a data content classification associated with data to be synchronized between the device and a cloud. The device of this example may further include a synchronization policy database configured to store synchronization policies, the policies based on the device usage context, the data content classification and a classification of the cloud type. The device of this example may further include a synchronization policy management module configured to select a synchronization policy from the synchronization policy database and further configured to synchronize the data with the cloud based on the selected synchronization policy.

Another example device includes the forgoing components and the context determination module includes a location determination module configured to estimate a location of the device and a clock module configured to determine a date and time, the usage context including the location and the date and time.

Another example device includes the forgoing components and the location determination module includes a GPS receiver.

Another example device includes the forgoing components and the location determination module includes a mobile cell identification module.

Another example device includes the forgoing components and further includes a device classification module configured to classify the device into one or more categories, and the categories are business, personal, private, or shared, and the synchronization policies are further based on the device classification.

Another example device includes the forgoing components and the data content classifications are business, personal, family, private or public.

Another example device includes the forgoing components and the cloud types are enterprise clouds, shared enterprise clouds, secured enterprise clouds, secured private clouds, home clouds or public clouds.

According to another aspect there is provided a method. The method may include determining a usage context associated with the device. The method of this example may also include determining a data content classification associated with data to be synchronized between the device and a cloud. The method of this example may further include selecting a synchronization policy from a synchronization policy database, the synchronization policies based on the device usage context, the data content classification and a classification of the cloud type. The method of this example may further include synchronizing the data with the cloud based on the selected synchronization policy.

Another example method includes the forgoing operations and the usage context includes a location of the device and a date and time.

Another example method includes the forgoing operations and further includes classifying the device into one or more categories, and the categories are business, personal, private, or shared, and the synchronization policies are further based on the device classification.

Another example method includes the forgoing operations and the data content classifications are business, personal, family, private or public.

Another example method includes the forgoing operations and the cloud types are enterprise clouds, shared enterprise clouds, secured enterprise clouds, secured private clouds, home clouds or public clouds.

According to another aspect there is provided a platform. The platform may include a processor; a memory coupled to the processor; an I/O system coupled to the processor; a user interface coupled to the I/O system; and a synchronization management module including. The synchronization management module of this example may include a context determination module configured to determine a usage context associated with the platform. The synchronization management module of this example may also include a content determination module configured to determine a data content classification associated with data to be synchronized between the platform and a cloud. The synchronization management module of this example may further include a synchronization policy database configured to store synchronization policies, the policies based on the platform usage context, the data content classification and a classification of the cloud type. The synchronization management module of this example may further include a synchronization policy management module configured to select a synchronization policy from the synchronization policy database and further configured to synchronize the data with the cloud based on the selected synchronization policy.

Another example platform includes the forgoing components and the context determination module includes a location determination module configured to estimate a location of the platform and a clock module configured to determine a date and time, the usage context including the location and the date and time.

Another example platform includes the forgoing components and the location determination module includes a GPS receiver.

Another example platform includes the forgoing components and the location determination module includes a mobile cell identification module.

Another example platform includes the forgoing components and further includes a platform classification module configured to classify the platform into one or more categories, and the categories are business, personal, private, or shared, and the synchronization policies are further based on the platform classification.

Another example platform includes the forgoing components and the data content classifications are business, personal, family, private or public.

Another example platform includes the forgoing components and the platform is a smartphone, a laptop computing device, a smart TV or a tablet.

Another example platform includes the forgoing components and the user interface is a touchscreen.

According to another aspect there is provided a system. The system may include a means for determining a usage context associated with the device. The system of this example may also include a means for determining a data content classification associated with data to be synchronized between the device and a cloud. The system of this example may further include a means for selecting a synchronization policy from a synchronization policy database, the synchronization policies based on the device usage context, the data content classification and a classification of the cloud type. The system of this example may further include a means for synchronizing the data with the cloud based on the selected synchronization policy.

Another example system includes the forgoing components and the usage context includes a location of the device and a date and time.

Another example system includes the forgoing components and further includes a means for classifying the device into one or more categories, and the categories are business, personal, private, or shared, and the synchronization policies are further based on the device classification.

Another example system includes the forgoing components and the data content classifications are business, personal, family, private or public.

Another example system includes the forgoing components and the cloud types are enterprise clouds, shared enterprise clouds, secured enterprise clouds, secured private clouds, home clouds or public clouds.

According to another aspect there is provided at least one computer-readable storage medium having instructions stored thereon which when executed by a processor, cause the processor to perform the operations of the method as described in any of the examples above.

According to another aspect there is provided an apparatus including means to perform a method as described in any of the examples above.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. A device for synchronization policy management, said device comprising:
a context determination module configured to determine a usage context associated with said device;
a content determination module configured to determine a data content classification associated with data to be synchronized between said device and a cloud;
a synchronization policy database configured to store synchronization policies, said policies based on said device usage context, said data content classification and a classification of said cloud type; and
a synchronization policy management module configured to select a synchronization policy from said synchronization policy database and further configured to synchronize said data with said cloud based on said selected synchronization policy.

2. The device of claim 1, wherein said context determination module comprises a location determination module configured to estimate a location of said device and a clock module configured to determine a date and time, said usage context comprising said location and said date and time.

3. The device of claim 2, wherein said location determination module comprises a Global Positioning System (GPS) receiver.

4. The device of claim 2, wherein said location determination module comprises a mobile cell identification module.

5. The device of claim 1, further comprising a device classification module configured to classify said device into one or more categories, wherein said categories are business, personal, private, or shared, and said synchronization policies are further based on said device classification.

6. The device of claim 1, wherein said data content classifications are business, personal, family, private or public.

7. The device of claim 1, wherein said cloud types are enterprise clouds, shared enterprise clouds, secured enterprise clouds, secured private clouds, home clouds or public clouds.

8. A method for device synchronization policy management, said method comprising:
determining a usage context associated with said device;
determining a data content classification associated with data to be synchronized between said device and a cloud;
selecting a synchronization policy from a synchronization policy database, said synchronization policies based on said device usage context, said data content classification and a classification of said cloud type; and
synchronizing said data with said cloud based on said selected synchronization policy.

9. The method of claim 8, wherein said usage context comprises a location of said device and a date and time.

10. The method of claim 8, further comprising classifying said device into one or more categories, wherein said categories are business, personal, private, or shared, and said synchronization policies are further based on said device classification.

11. The method of claim 8, wherein said data content classifications are business, personal, family, private or public.

12. The method of claim 8, wherein said cloud types are enterprise clouds, shared enterprise clouds, secured enterprise clouds, secured private clouds, home clouds or public clouds.

13. A computer-readable storage medium having instructions stored thereon which when executed by a processor result in the following operations for device synchronization policy management, said operations comprising:
determining a usage context associated with said device;
determining a data content classification associated with data to be synchronized between said device and a cloud;
selecting a synchronization policy from a synchronization policy database, said synchronization policies based on said device usage context, said data content classification and a classification of said cloud type; and
synchronizing said data with said cloud based on said selected synchronization policy.

14. The computer-readable storage medium of claim 13, wherein said usage context comprises a location of said device and a date and time.

15. The computer-readable storage medium of claim 13, further comprising the operation of classifying said device into one or more categories, wherein said categories are business, personal, private, or shared, and said synchronization policies are further based on said device classification.

16. The computer-readable storage medium of claim 13, wherein said data content classifications are business, personal, family, private or public.

17. The computer-readable storage medium of claim 13, wherein said cloud types are enterprise clouds, shared enterprise clouds, secured enterprise clouds, secured private clouds, home clouds or public clouds.

18. A platform with synchronization policy management, said platform comprising:
a processor;
a memory coupled to said processor;
an input/output (I/O) system coupled to said processor;
a user interface coupled to said I/O system; and
a synchronization management module comprising:
a context determination module configured to determine a usage context associated with said platform;
a content determination module configured to determine a data content classification associated with data to be synchronized between said platform and a cloud;
a synchronization policy database configured to store synchronization policies, said policies based on said platform usage context, said data content classification and a classification of said cloud type; and
a synchronization policy management module configured to select a synchronization policy from said synchronization policy database and further configured to synchronize said data with said cloud based on said selected synchronization policy.

19. The platform of claim 18, wherein said context determination module comprises a location determination module configured to estimate a location of said platform and a clock module configured to determine a date and time, said usage context comprising said location and said date and time.

20. The platform of claim 18, wherein said location determination module comprises a Global Positioning System (GPS) receiver.

21. The platform of claim 18, wherein said location determination module comprises a mobile cell identification module.

22. The platform of claim 18, further comprising a platform classification module configured to classify said platform into one or more categories, wherein said categories are business, personal, private, or shared, and said synchronization policies are further based on said platform classification.

23. The platform of claim 18, wherein said data content classifications are business, personal, family, private or public.

24. The platform of claim 18, wherein said platform is a smartphone, a laptop computing device, a smart TV or a tablet.

25. The platform of claim 18, wherein said user interface is a touchscreen.
